(19) United States
(12) Patent Application Publication
(10) Pub. No.: US 2012/0223941 A1
(43) Pub. Date: Sep. 6, 2012

(54) IMAGE DISPLAY APPARATUS, METHOD, AND RECORDING MEDIUM

(76) Inventors: Masahiro Sekine, Fuchu-shi (JP); Yasunori Taguchi, Kawasaki-shi (JP); Toshiyuki Ono, Kawasaki-shi (JP); Nobuyuki Matsumoto, Inagi-shi (JP)

(21) Appl. No.: 13/240,720

(22) Filed: Sep. 22, 2011

(30) Foreign Application Priority Data
Mar. 4, 2011 (JP) 2011-048299

(51) Int. Cl. G06T 15/00; G09G 5/02

(52) U.S. Cl. 345/419; 345/589

(57) ABSTRACT

According to one embodiment, an image display apparatus includes a display including a light ray controller and a light-emitting panel, an image acquisition unit, an interpolation process unit, and a sub-pixel rearrangement process unit. The image acquisition unit acquires a first image. The interpolation process unit performs an interpolation process for the first image to generate a second image. The interpolation process calculates a color of a first phase which is determined from a display specification including at least one of a size, tilt, and arrangement interval of the light ray controller, a pitch of sub pixels of the light emitting panel, and an arrangement of color filters. The sub-pixel rearrangement process unit generates a third image by rearranging colors in the second image for each sub-pixel. The light-emitting panel illuminates the third image.

### CROSS-REFERENCE TO RELATED APPLICATIONS

This application is based upon and claims the benefit of priority from prior Japanese Patent Application No. 2011-048299, filed Mar. 4, 2011, the entire contents of which are incorporated herein by reference.

### FIELD

Embodiments described herein relate generally to a technique of processing an image or video to be displayed on a stereoscopic display.

### BACKGROUND

In recent years, with rapid advances in development of stereoscopic image display apparatuses, that is, stereoscopic displays, various schemes have been proposed. Especially a scheme which requires, for example, no special spectacles has been proposed and is attracting a great deal of attention. As a scheme of a stereoscopic display which can be implemented relatively easily, a stereoscopic display including a light ray controller provided on the front surface of a light-emitting panel is available. The light-emitting panel uses, for example, a direct-view or projection type liquid crystal panel or plasma panel, and has a fixed pixel position. The light ray controller controls the direction of a light ray traveling from the light-emitting panel to the observer (user). More specifically, this light ray is controlled so that the observer can observe different images in accordance with the angle at which he or she observes the same position on the light ray controller. If only a horizontal parallax is to be produced, a lenticular lens (cylindrical lens array) or a parallax barrier is used. If not only a horizontal parallax but also a vertical parallax is to be produced, a pinhole array or a lens array is used. Schemes which use the light ray controller are classified into a twin-lens scheme, a multi-lens scheme, and integral photography in accordance with the difference in scheme of light ray control.

A technique of displaying an image free from parallaxes using such a stereoscopic display, that is, performing 2D display using this stereoscopic display has been proposed.

### BRIEF DESCRIPTION OF THE DRAWINGS

FIG. 1 is a block diagram of an image display apparatus according to the first embodiment;

FIG. 2 is a view for explaining the specification of a display including a light ray controller;

FIGS. 3A, 3B, 3C and 3D are views for explaining determination of a first phase based on the display specification;

FIGS. 4A and 4B are views showing the types of methods of determining a first phase;

FIGS. 5A and 5B are views for explaining determination of a first phase corresponding to the horizontal position of the display;

FIG. 6 is a view for explaining a method of a sub-pixel rearrangement process;

FIG. 7 is a flowchart showing the process of the image display apparatus;

FIG. 8 is a block diagram of an image display apparatus obtained by adding a sharpening process unit;

FIGS. 9A, 9B, 9C and 9D are views for explaining a method of a sharpening process;

FIG. 10 is a flowchart showing the process of the image display apparatus obtained by adding the sharpening process unit;

FIG. 11 is a block diagram of an image display apparatus obtained by adding a viewpoint position acquisition unit;

FIGS. 12A, 12B and 12C are views for explaining determination of a first phase corresponding to the user's viewpoint position;

FIG. 13 is a flowchart showing the process of the image display apparatus obtained by adding the viewpoint position acquisition unit;

FIG. 14 is a block diagram of an image display apparatus obtained by adding a display specification acquisition unit;

FIG. 15 is a flowchart showing the process of the image display apparatus obtained by adding the display specification acquisition unit;

FIG. 16 is a block diagram of an image display apparatus according to the second embodiment;

FIGS. 17A, 17B and 17C are views for explaining a method of dividing 2D/3D display regions;

FIGS. 18A and 18B are views for explaining a method of compositing the 2D/3D display regions; and

FIG. 19 is a flowchart showing the process of the image display apparatus which performs separate processes for the 2D/3D display regions.

### DETAILED DESCRIPTION

In general, according to one embodiment, there is provided an image display apparatus comprising a display including a light ray controller and a light-emitting panel, an image acquisition unit, an interpolation process unit, and a sub-pixel rearrangement process unit. The image acquisition unit acquires a first image. The interpolation process unit performs an interpolation process for the first image to generate a second image. The interpolation process calculates a color of a first phase which is determined from a display specification including at least one of a size, tilt, and arrangement interval of the light ray controller, a pitch of sub pixels of the light emitting panel, and an arrangement of color filters. The sub-pixel rearrangement process unit generates a third image by rearranging colors in the second image for each sub-pixel. The light-emitting panel illuminates the third image.

Embodiments will be described below with reference to the accompanying drawings. These embodiments relate to an improvement in image quality when 2D display is performed on a stereoscopic display. In this specification, “2D display” means displaying an image free from parallaxes using an image display apparatus which can provide stereoscopic vision. In the embodiments to be described hereinafter, the image quality is improved while suppressing “flicker” and “color shifts” that may occur when 2D display is performed on a stereoscopic display which employs a light ray controller typified by a lenticular lens or a parallax barrier.

The first embodiment shows details of a series of processes of an image display apparatus which performs an interpolation process and a sub-pixel rearrangement process. Also, the first modification in which a sharpening process unit is added, the second modification in which a viewpoint position acquisition unit is added, and the third modification in which a display specification acquisition unit is added will be described as several modifications to the first embodiment. The second embodiment shows details of a series of processes of an image display apparatus when a 2D display region and a 3D display region mix with each other. A process of dividing an image into a 2D display region and a 3D display region, performing separate processes for the respective regions, and then compositing the 2D display region and the 3D display region will be described.

### First Embodiment

The first embodiment will be described first. An image display apparatus according to this embodiment performs an interpolation process and a sub-pixel rearrangement process in accordance with a phase which is determined from a display specification including at least one of the size, tilt, and arrangement interval of a light ray controller, the pitch of sub-pixels of a light-emitting panel, and the arrangement of color filters. In the interpolation process, the color of a phase that is required at the precision of sub-pixel order is calculated. In the sub-pixel rearrangement process, colors are rearranged for each sub-pixel.

With these processes, when 2D display is performed on a stereoscopic display which employs a light ray controller typified by a lenticular lens or a parallax barrier, the image quality can be improved while suppressing flicker and color shifts.

An image display apparatus which implements 2D display according to this embodiment will be described in detail below.

### <<Entire Configuration>>

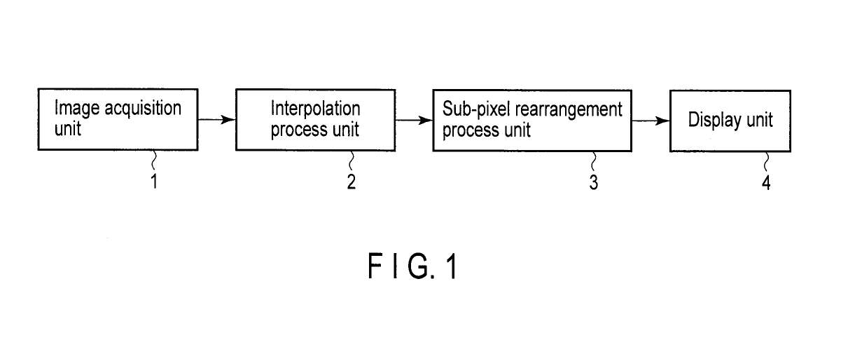

FIG. 1 is a block diagram showing the entire configuration of the image display apparatus according to the first embodiment. The image display apparatus according to this embodiment includes a display unit (display) 4, image acquisition unit 1, interpolation process unit 2, and sub-pixel rearrangement process unit 3. The display unit 4 includes a light ray controller and light-emitting panel, and displays an image. The image acquisition unit 1 acquires image 1. The interpolation process unit 2 generates image 2 by calculating, by an interpolation process for image 1, the color of a first phase which is determined from a display specification. The sub-pixel rearrangement process unit 3 generates image 3 by rearranging colors in image 2 for each sub-pixel. The display specification includes at least one of the size, tilt, and arrangement interval of the light ray controller, the pitch of sub-pixels of the light-emitting panel, and the arrangement of color filters. The light-emitting panel emits light in accordance with image 3 generated by the sub-pixel rearrangement process unit 3.

Each of the above-mentioned constituent elements of the image display apparatus according to this embodiment will be described in detail below.

### <Display Unit>

The display unit 4 will be described first. In this embodiment, a display which includes a light ray controller and light-emitting panel and is capable of 3D display is assumed as the display unit 4.

FIG. 2 illustrates an example of a display applied to the display unit 4. This display includes a light-emitting panel 23 having a fixed pixel position, such as a direct-view or projection liquid crystal panel or plasma panel. The light-emitting panel 23 has, as a unit, a sub-pixel which emits primary colors to determine the color of each pixel, and uses a color filter which determines a color to be emitted by each sub-pixel. Also, a light ray controller 22 capable of controlling the direction of a light ray traveling from the light-emitting panel 23 to the user is provided on the front surface of the light-emitting panel 23. A lenticular lens or a parallax barrier is often used as the light ray controller 22.

Main parameters which determine the specification of such a display will be described. Parameters, as shown in FIG. 2, are used mainly. The horizontal dimension (width) of the display is defined as Wd, and its vertical dimension (height) is defined as hd. As for the light-emitting panel 23, the width (pitch) of sub-pixels is defined as Wp, the height of each sub-pixel is defined as hp, and the arrangement of color filters is defined as ColorArray (i, j) (Enlargement B in FIG. 2). Note that i and j are the horizontal and vertical coordinates, respectively, of each sub-pixel arranged on the light-emitting panel 23. When red is defined as R, green is defined as G, and blue is defined as B in three primary colors, many light-emitting panels generally adopt a periodic array such as RGBRGB . . . in accordance with a change in horizontal direction. Although such an array will be taken as an example in this embodiment, the embodiment is not always limited to this array method.

As for the light ray controller 22, the tilt of periodically arranged elements of the light ray controller 22 with respect to the axis of the display in the vertical direction is defined as θ, and their horizontal dimension (width) is defined as We. Also, as shown in enlargement A of FIG. 2, when a parallax barrier is used as the light ray controller 22, the horizontal dimension (width) of a slit 20 formed between barriers 21 is defined as Ws. Application to a stereoscopic display which can produce a parallax in the horizontal direction as in this case will be taken as an example in this embodiment. However, when a stereoscopic display which can produce a parallax in the vertical direction using, for example, a pinhole array or a lens array is employed, it can be operated in the same way as in the former stereoscopic display, upon including the vertical dimensions (heights) as parameters.

Light emitted by the light-emitting panel 23 of the display as mentioned above can display an image upon passing through the light ray controller 22.

### <Image Acquisition Unit>

The image acquisition unit 1 will be described next. The image acquisition unit 1 acquires image 1 as a source image before a process for generating an image to be displayed on the display.

### <Interpolation Process Unit>

The interpolation process unit 2 will be described next. In this case, the interpolation process unit 2 generates image 2 by calculating, by an interpolation process for image 1, the color of a first phase which is determined from a display specification including at least one of the size, tilt, and arrangement interval of the light ray controller, the pitch of sub-pixels of the light-emitting panel, and the arrangement of color filters. The first phase means a phase which is determined from the display specification and is necessary for image display.

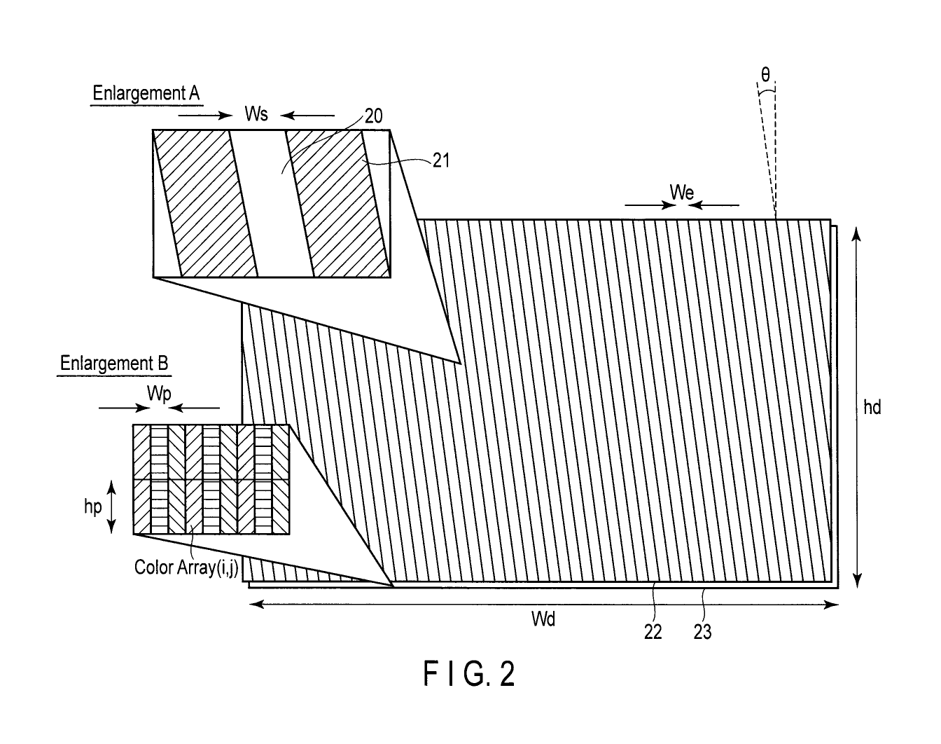

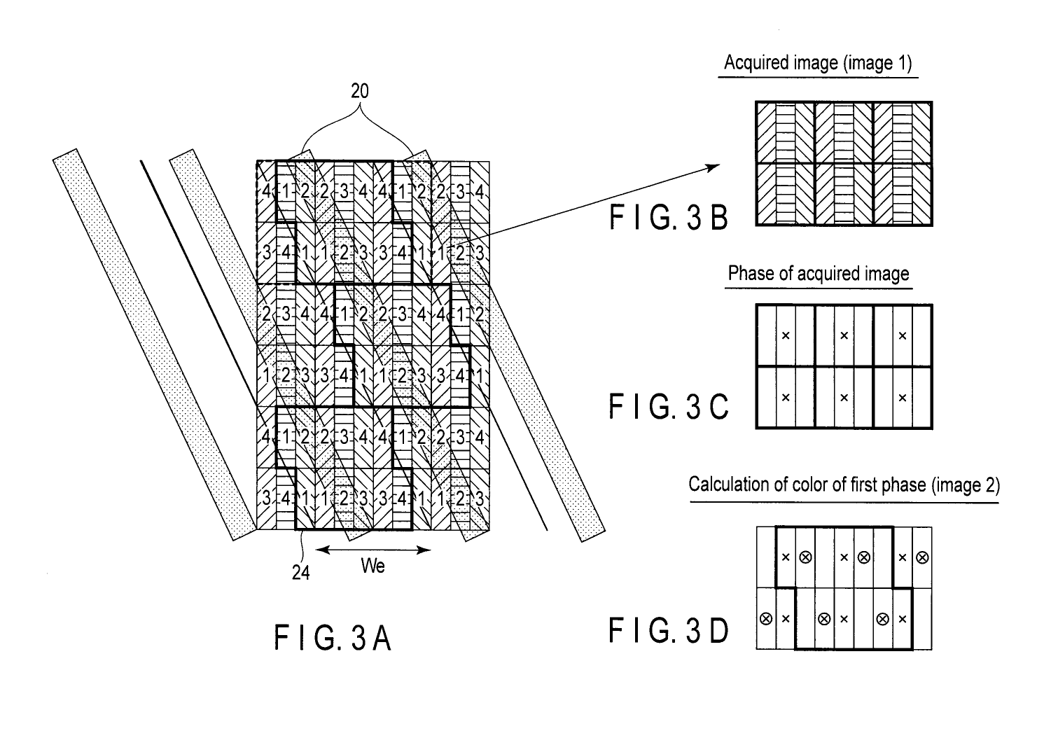

A method of determining a first phase based on the display specification will be described with reference to FIGS. 3A to 3D.

FIG. 3A illustrates an example of the display specification. Each region in which colors having a plurality of parallaxes are to be rendered for the same phase in 3D display will be referred to as a “block” hereinafter. In this case, the display can be divided into a plurality of blocks, as shown in FIG. 3A. This display corresponds to a stereoscopic display having four parallaxes, and thus can implement stereoscopic vision as long as each pixel is rendered using the colors of images having parallax numbers 1 to 4.

Each block includes 12 sub-pixels (corresponding to 3 (colors)×4 (parallaxes)). On the other hand, acquired image 1 will be considered. A normal image includes, as one pixel, three colors arranged in the order of RGB, as shown in FIG. 3B. The color of each of these pixels is present in a portion having the phase of the center of the pixel (the phase of the center of G color of the sub-pixel), so the phases of the respective pixels are arrayed in a grid pattern equidistantly in the vertical and horizontal directions, as shown in FIG. 3D. As can be seen from the shape of the above-mentioned block which is determined from the display specification, the colors of the already existing phases do not perfectly fall within this block. Hence, FIG. 3D shows determination of, for example, a phase (to be referred to as a first phase hereinafter) used to maximize the number of colors within the block. In this case, four first phases are determined within a given block. In this manner, by determining a plurality of first phases within each block, and rendering the colors of these phases within this block, the image quality can be improved while suppressing flicker and color shifts. This effect can be enhanced by maximizing the number of colors (four colors for a display having four parallaxes).

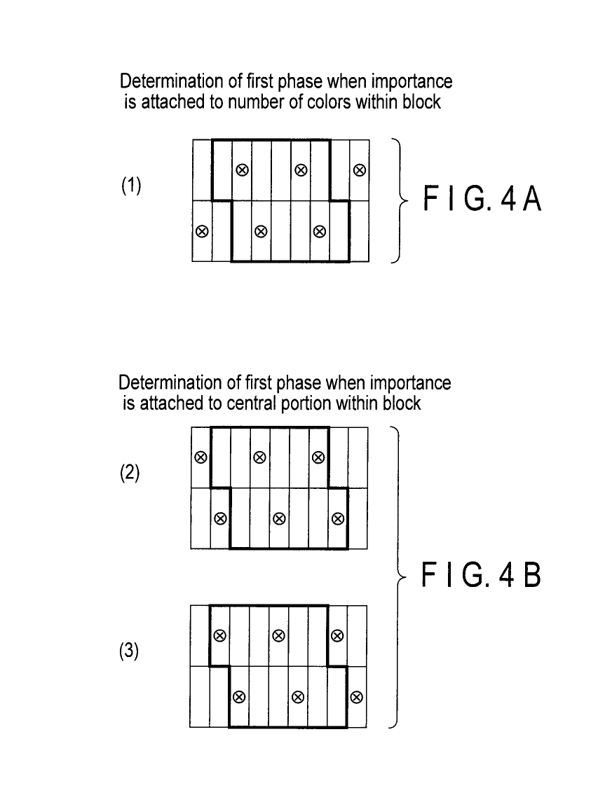

Other methods of determining a first phase will be described. FIG. 4A shows another type of method of determining a first phase. FIG. 4A shows a method of determining a first phase when importance is attached to the number of colors within the above-mentioned block. In this method, only little flicker and color shifts occur between the blocks because the colors of all of the four first phases can be rendered within the block. However, flicker and color shifts may occur if different colors are simultaneously observed, when viewed from the front side. On the other hand, FIG. 4B shows a method of determining a first phase when importance is attached to the central portion within the block. When this block is observed from the front side via the light ray controller, the color of the central portion within the block becomes predominant. Thus, flicker and color shifts can be reduced more so that stable colors can be observed, when viewed from the front side. However, flicker and color shifts may occur between the blocks. These methods of determining a first phase can selectively be used in accordance with the purpose of use.

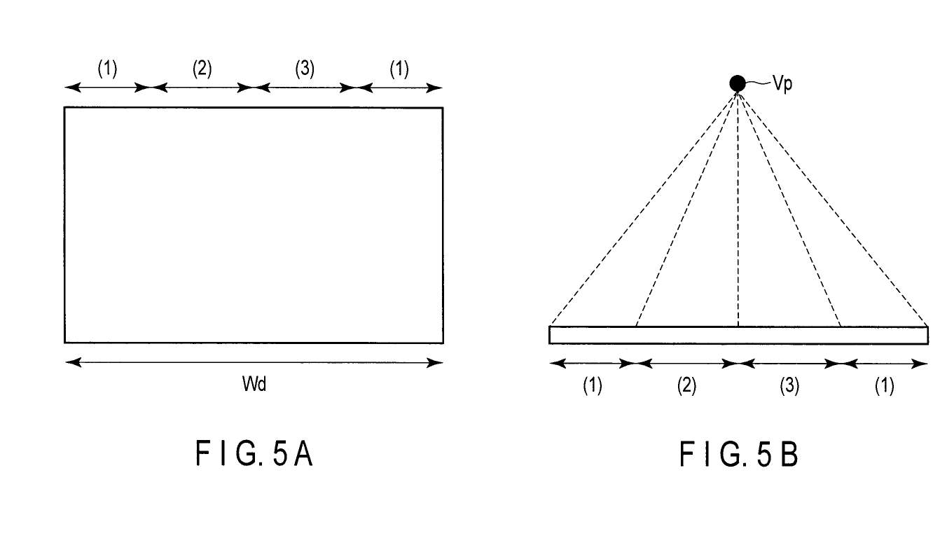

A method of switching, on the same display, the method of determining a first phase is also available. A method of determining a first phase corresponding to the horizontal position of the display will be described with reference to FIGS. 5A and 5B. A viewpoint Vp of the user who observes a certain display can be assumed for this display. When the user observes the display, as shown in FIG. 5B, he or she observes a light ray, which is traveling in a direction close to that of a normal to the display surface, in each element of the light ray controller, in the vicinity of the center of the display in the horizontal direction. The user observes light rays, which are tilted from the direction of a normal to the display surface, in each element of the light ray controller, in the vicinities of the right and left ends of the display in the horizontal direction. In other words, the user can mainly see the color of the central portion within the block, in the vicinity of the center of the display in the horizontal direction, and can see the colors of the end portions within the block, in the vicinities of the right and left ends of the display in the horizontal direction. Hence, the method of determining a first phase may be switched in accordance with the horizontal position of the display to selectively use (1) to (3) in FIGS. 4A and 4B, thereby determining a first phase, as shown in FIG. 5B.

A method of an interpolation process for calculating the color of the determined first phase will be described next. The interpolation method can not only use a widely well-known interpolation process algorithm, but also use, for example, linear interpolation, polynomial interpolation, or interpolation which uses a function model.

### <Sub-pixel Rearrangement Process Unit>

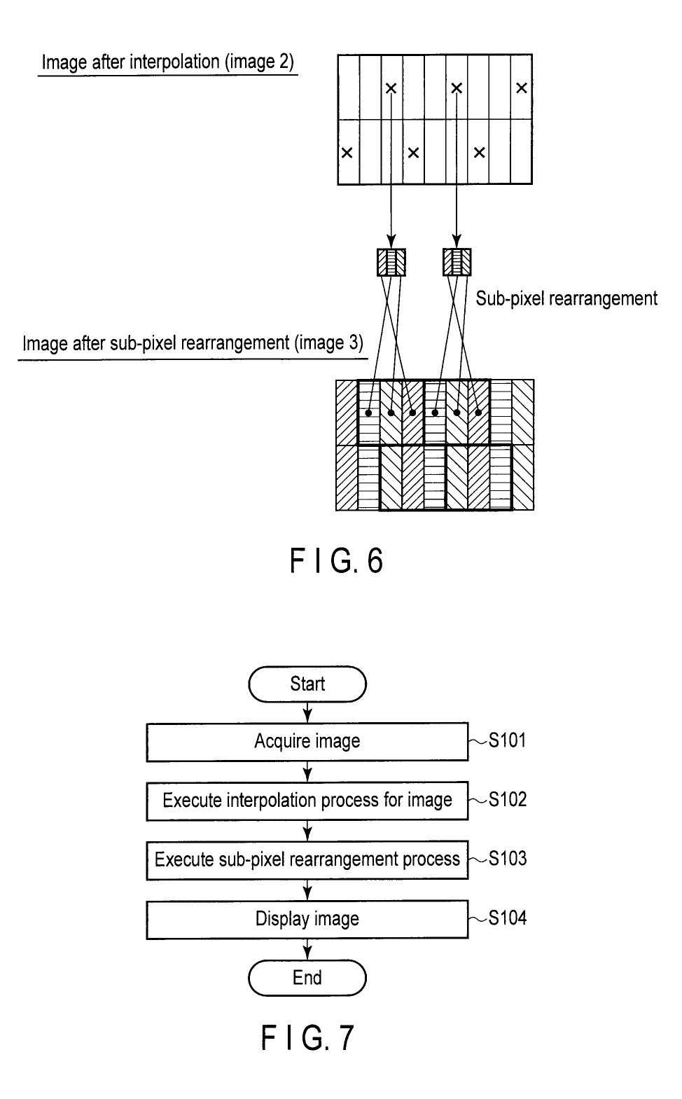

The sub-pixel rearrangement process unit 3 will be described next. In this case, the sub-pixel rearrangement process unit 3 generates image 3 by rearranging colors in image 2 for each sub-pixel. FIG. 6 shows a method of a sub-pixel rearrangement process. Image 2 generated by the interpolation process unit 2 is an image having colors arrayed in a grid pattern in accordance with the first phases, and therefore includes, as one pixel, three colors arranged in the order of RGB, like a normal image. However, pixels (three pixels in this case) having the first phase at their center are not always pixels having colors arranged in the order of RGB. In the example illustrated in FIG. 6, pixels on the upper row have colors arranged in the order of GBR, while those on the lower row have colors arranged in the order of BRG. Hence, image 3 is generated by sorting (rearranging) colors in image 2 for each sub-pixel.

### <<Overall Operation>>

FIG. 7 is a flowchart illustrating an example of the operation of the image display apparatus according to this embodiment.

First, in step S101, an image is acquired. The image acquisition unit 1 executes this process. In this case, the image acquisition unit 1 acquires image 1. Next, in step S102, an interpolation process is executed for the image. The interpolation process unit 2 executes this process. In this case, the interpolation process unit 2 generates image 2 by calculating, by an interpolation process for image 1, the color of a first phase which is determined from a display specification including at least one of the size, tilt, and arrangement interval of the light ray controller, the pitch of sub-pixels of the light-emitting panel, and the arrangement of color filters. In step S103, a sub-pixel rearrangement process is executed. The sub-pixel rearrangement process unit 3 executes this process. In this case, the sub-pixel rearrangement process unit 3 generates image 3 by rearranging colors in image 2 for each sub-pixel. Lastly, in step S104, the image is displayed. The display unit 4 executes this process. In this case, the display unit 4 uses a display including a light ray controller and light-emitting panel to illuminate image 3 by the light-emitting panel.

With such processes, when 2D display is performed on a stereoscopic display which employs a light ray controller typified by a lenticular lens or a parallax barrier, the image quality can be improved while suppressing flicker and color shifts.

### (First Modification)

### <<Entire Configuration>>

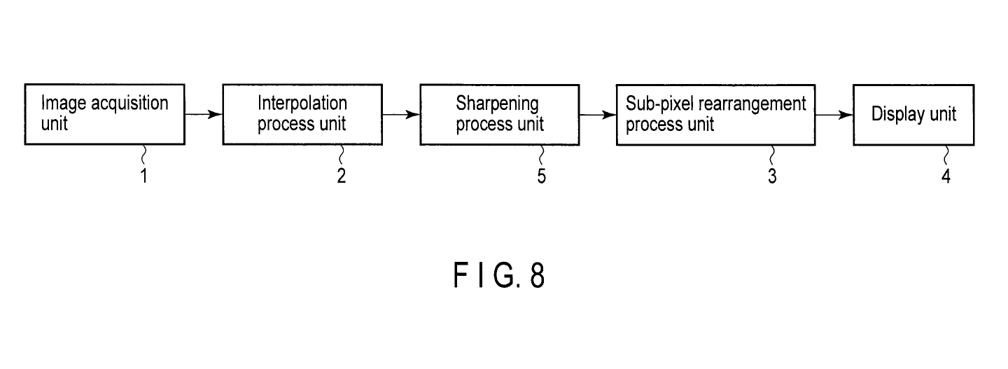

FIG. 8 is a block diagram of an image display apparatus obtained by adding a sharpening process unit to the image display apparatus according to the first embodiment. The image display apparatus according to the first modification is configured by adding a sharpening process unit 5 to the image display apparatus according to the first embodiment. The sharpening process unit 5 generates image 4 by performing a sharpening process for image 2 based on a second phase which is determined from the display specification. The sub-pixel rearrangement process unit 3 generates image 3 by rearranging colors in image 4 in place of image 2 for each sub-pixel.

Each added or changed unit will be described in detail below.

### <Sharpening Process Unit>

The sharpening process unit 5 will be described first. In this case, the sharpening process unit 5 generates image 4 by performing a sharpening process for image 2 based on a second phase which is determined from the display specification.

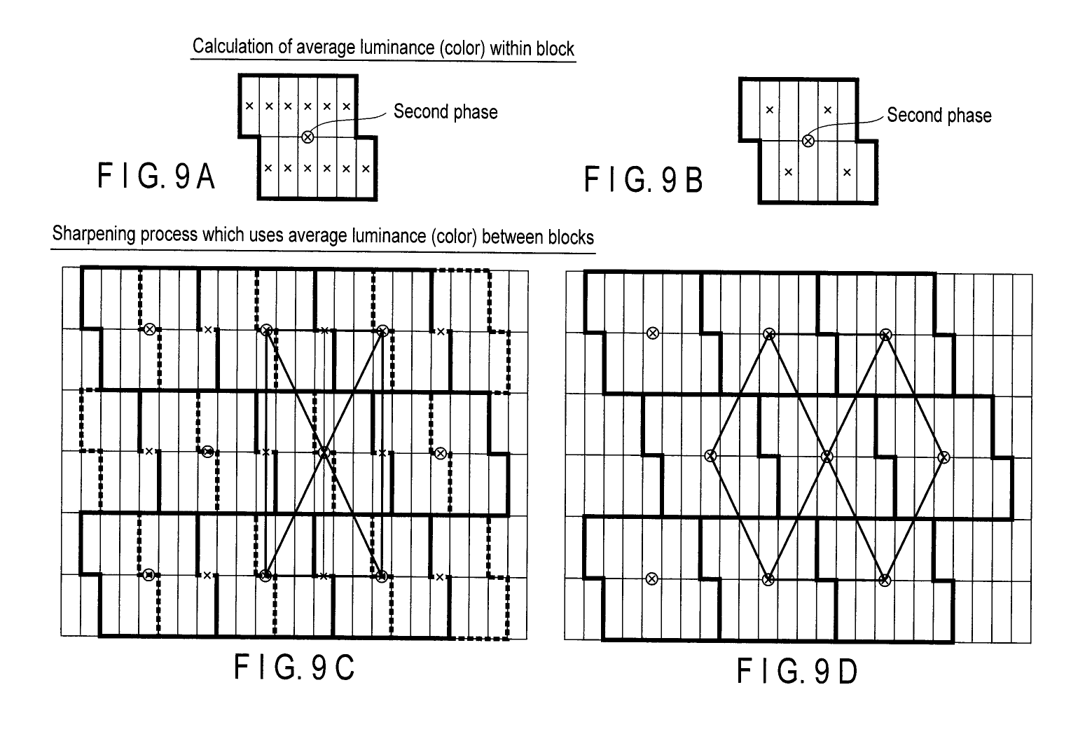

A method of a sharpening process will be described with reference to FIGS. 9A to 9D. The second phase means the phase of the center of the block, which is determined from the display specification. In this case, the luminance or color of the second phase is obtained first. The same interpolation process as in the interpolation process unit 2 may be performed, or the average of the luminances or colors of phases present within the block may be obtained. FIGS. 9A and 9B show calculation of the average luminance (color) within the block. FIG. 9A illustrates a case in which the luminances (colors) of the center phases of all of 12 sub-pixels are known, so the average of 12 luminances (colors) is obtained. FIG. 9B illustrates a case in which the luminances (colors) of the center phases of four sub-pixels having the first phases are known, so the average of four luminances (colors) is obtained. The luminances (colors) mentioned herein may be calculated using any color space such as an RGB color space, or calculated using only Y components (luminance components) in a YCBCr color space. Note that both the color and the luminance will be referred to as a color hereinafter. The average color obtained in a given block is defined as Ca.

The difference between the color of the first phase obtained within each block and the average color obtained in this block is calculated next. Letting C1 be the color of a given first phase obtained within a given block, the difference between the color C1 and the average color Ca obtained in this block can be calculated by:

Cs1=C1−Ca.

After the color of a second phase as in this case is obtained, a sharpening process which uses the average color between the blocks is performed, as shown in FIGS. 9C and 9D. If the light ray controller has a nonzero tilt θ, that is, is tilted with respect to the axis of the display in the vertical direction, the second phase may shift in accordance with the vertical coordinate (the number of rows) of each sub-pixel. In such a case, a method of increasing the number of average colors to be obtained, using a virtual block (dotted line) so that second phases are arrayed in a grid pattern is available, as shown in FIG. 9C. This makes it possible to perform a sharpening process (unsharp mask process) like that generally used in image processing. On the other hand, FIG. 9D shows a case in which second phases are not arrayed in a grid pattern, so a sharpening process is performed using the average color of neighboring blocks. In this case, a sharpening process is performed using the average color of neighboring blocks in a hexagonal shape. Such a method obviates the need to obtain additional average colors, thereby making it possible to reduce the amount of calculation and the memory size used. The average color obtained in a given block is defined as Ca, and that after sharpening upon performing a sharpening process as mentioned above is defined as Ca′.

Lastly, the sum of the difference between the color of the first phase obtained within each block and the average color obtained in this block and the average color after sharpening is obtained, thereby making it possible to obtain the color of the first phase after sharpening. Letting C1′ be the color obtained after sharpening the color of a given phase obtained within a given block, the color C1′ can be calculated by:

C1′=Cs1+Ca′.

By performing a sharpening process using a method as mentioned above, a change in color between the blocks can be sharpened without varying the change in color within each block. Regeneration of flicker and color shifts can be suppressed by not varying the change in color within each block, and the sharpness of the entire image can be enhanced by sharpening the change in color between the blocks.

### <Sub-pixel Rearrangement Process Unit>

The sub-pixel rearrangement process unit 3 will be described next. In this case, the sub-pixel rearrangement process unit 3 generates image 3 by rearranging colors in image 4 in place of image 2 for each sub-pixel. An image with higher sharpness can be generated by generating image 3 using an image after a sharpening process (image 4) in place of an image before a sharpening process (image 2).

### <<Overall Operation>>

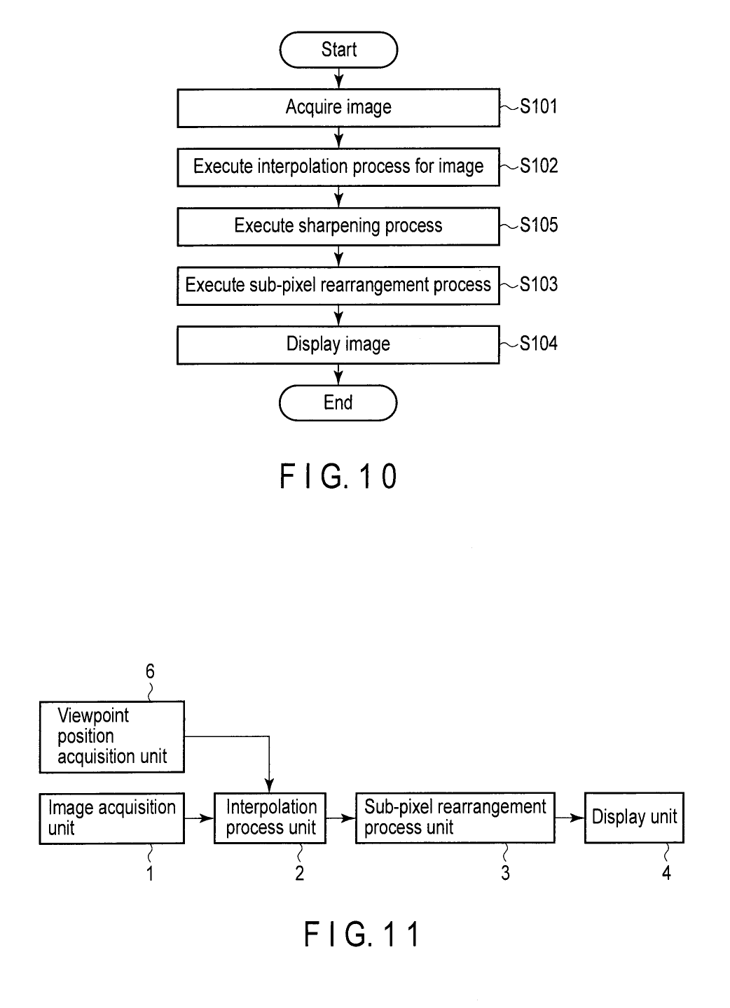

FIG. 10 is a flowchart illustrating an example of the operation of the image display apparatus according to the first modification. Differences from the operation of the above-mentioned image display apparatus will mainly be described below.

First, in steps S101 and S102, the same operations as in the above-mentioned image display apparatus are executed. Next, in step S105, a sharpening process is executed. The sharpening process unit 5 executes this process. In this case, the sharpening process unit 5 generates image 4 by performing a sharpening process for image 2 based on a second phase which is determined from the display specification. In step S103, a sub-pixel rearrangement process is executed. The sub-pixel rearrangement process unit 3 executes this process. In this case, the sub-pixel rearrangement process unit 3 generates image 3 by rearranging colors in image 4 for each sub-pixel. An operation in step S104 is the same as that in the above-mentioned image display apparatus.

With such processes, when 2D display is performed on a stereoscopic display which employs a light ray controller typified by a lenticular lens or a parallax barrier, the image quality can be improved while suppressing flicker and color shifts.

### (Second Modification)

### <<Entire Configuration>>

FIG. 11 is a block diagram of an image display apparatus obtained by adding a viewpoint position acquisition unit to the image display apparatus according to the first embodiment. The image display apparatus according to the second modification is configured by adding a viewpoint position acquisition unit 6 which acquires a user's viewpoint position to the image display apparatus according to the first embodiment. The interpolation process unit 2 generates image 2 by calculating a first phase from the display specification and the user's viewpoint position, and calculating the color of the calculated first phase by an interpolation process for image 1.

Each added or changed unit will be described in detail below.

### <Viewpoint Position Acquisition Unit>

The viewpoint position acquisition unit 6 will be described first. In this case, the viewpoint position acquisition unit 6 acquires a user's viewpoint position. The user's viewpoint position to be used may be automatically detected using a camera or an infrared sensor, or manually input by the user.

### <Interpolation Process Unit>

The interpolation process unit 2 will be described next. In this case, the interpolation process unit 2 generates image 2 by calculating a first phase from the display specification and the user's viewpoint position, and calculating the color of the calculated first phase by an interpolation process for image 1.

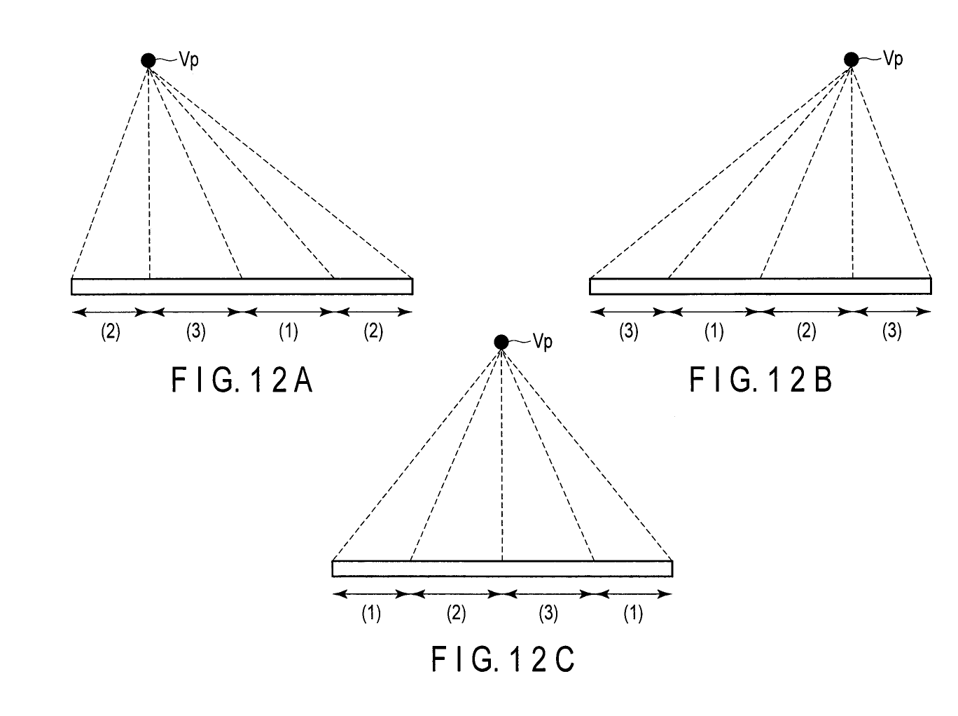

A method of determining a first phase in consideration of the user's viewpoint position as well, as in this modification, will be described with reference to FIGS. 12A to 12C. The concept of this method is the same as the method of determining a first phase corresponding to the horizontal position of the display shown in FIGS. 5A and 5B. In the case of FIGS. 5A and 5B, a certain fixed position is assumed as the user's viewpoint position. In contrast, in this modification, the method of determining a first phase is changed in accordance with the position of a user's viewpoint Vp, as shown in FIGS. 12A to 12C. On the left side of the display in the horizontal direction, the method of determining a first phase is changed in the order of (2)→(1)→(3)→(2)→(1)→(3)→ . . . from the side closer to a normal, which connects the position of the user's viewpoint Vp and the display surface to each other, to that farther from it, as shown in FIG. 12B. On the other hand, on the right side of the display in the horizontal direction, the method of determining a first phase is changed in the order of (3)→(1)→(2)→(3)→(1)→(2)→ . . . from the side closer to the normal to that farther from it, as shown in FIG. 12A.

In this manner, an image with higher quality can be displayed by changing the first phase in accordance with the acquired user's viewpoint position.

### <<Overall Operation>>

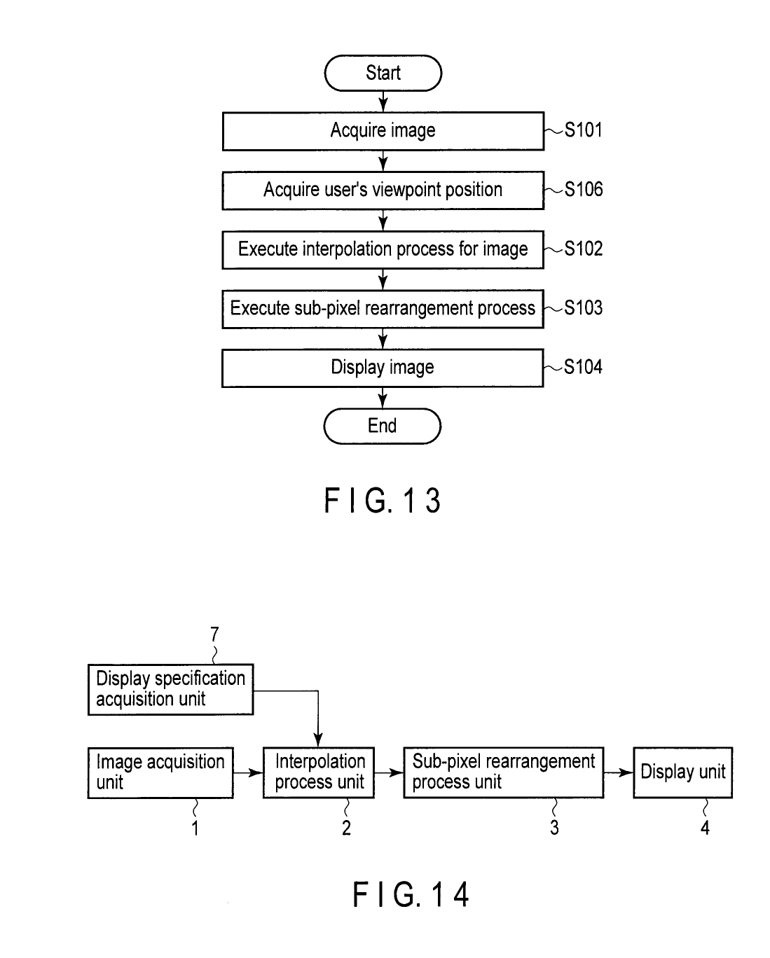

FIG. 13 is a flowchart illustrating an example of the operation of the image display apparatus according to the second modification. Differences from the operation of the above-mentioned image display apparatus will mainly be described below. First, in step S101, the same operation as in the above-mentioned image display apparatus is executed. Next, in step S106, a user's viewpoint position is acquired. The viewpoint position acquisition unit 6 executes this process. In this case, the viewpoint position acquisition unit 6 acquires a user's viewpoint position. In step S102, an interpolation process is executed for the image. The interpolation process unit 2 executes this process. In this case, the interpolation process unit 2 generates image 2 by calculating a first phase from the display specification and the user's viewpoint position, and calculating the color of the calculated first phase by an interpolation process for image 1. Operations in steps S103 and 5104 are the same as those in the above-mentioned image display apparatus.

With such processes, when 2D display is performed on a stereoscopic display which employs a light ray controller typified by a lenticular lens or a parallax barrier, the image quality can be improved while suppressing flicker and color shifts, and, additionally, an image with higher quality can be generated in accordance with the user's viewpoint.

### (Third Modification)

### <<Entire Configuration>>

FIG. 14 is a block diagram of an image display apparatus obtained by adding a display specification acquisition unit to the image display apparatus according to the first embodiment. The image display apparatus according to the third modification is configured by adding a display specification acquisition unit 7 which acquires a display specification to the image display apparatus according to the first embodiment. In this image display apparatus, the interpolation process unit 2 generates image 2 by calculating a first phase from the acquired display specification or the user's viewpoint position, and calculating the color of the calculated first phase by an interpolation process for image 1.

Each added or changed unit will be described in detail below.

### <Display Specification Acquisition Unit>

The display specification acquisition unit 7 will be described first. In this case, the display specification acquisition unit 7 acquires a display specification. A form input from outside the apparatus is assumed as the display specification.

### <Interpolation Process Unit>

The interpolation process unit 2 will be described next. In this case, the interpolation process unit 2 generates image 2 by calculating a first phase from the acquired display specification or the user's viewpoint position, and calculating the color of the calculated first phase by an interpolation process for image 1. When the display specification is fixed, the first phase is also fixed (note that a change corresponding to the user's viewpoint is excluded). However, in the configuration of the third modification, a first phase must be calculated every time a display specification is acquired. Once a first phase corresponding to a given display specification is calculated, it is preferable to store the calculation result in a storage unit such as a buffer or a database, and reuse it.

### <<Overall Operation>>

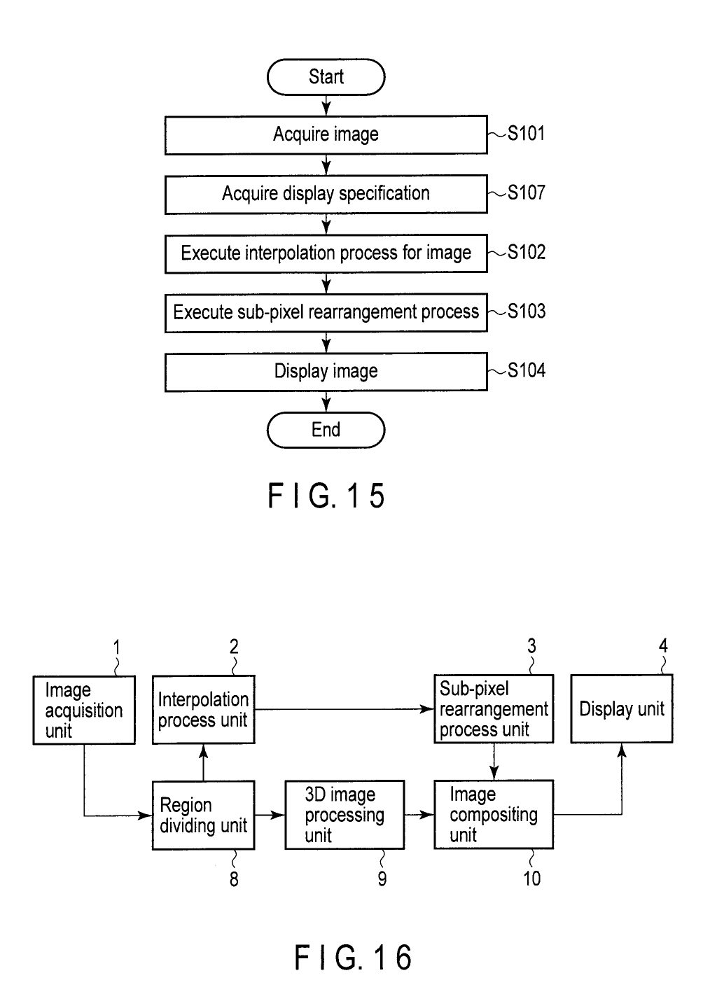

FIG. 15 is a flowchart illustrating an example of the operation of the image display apparatus according to the third modification. Differences from the operation of the above-mentioned image display apparatus will mainly be described below. First, in step S101, the same operation as in the above-mentioned image display apparatus is executed. Next, in step S107, a display specification is acquired. The display specification acquisition unit 7 executes this process. In step S102, an interpolation process is executed for the image. The interpolation process unit 2 executes this process. In this case, the interpolation process unit 2 generates image 2 by calculating a first phase from the acquired display specification or the user's viewpoint position, and calculating the color of the calculated first phase by an interpolation process for image 1. Operations in steps S103 and S104 are the same as those in the above-mentioned image display apparatus.

With such processes, when 2D display is performed on a stereoscopic display which employs a light ray controller typified by a lenticular lens or a parallax barrier, the image quality can be improved while suppressing flicker and color shifts, and, additionally, an image with higher quality can be generated in accordance with the display specification acquired from outside the apparatus.

In the above-mentioned first embodiment, an interpolation process and a sub-pixel rearrangement process are performed in accordance with a phase which is determined from a display specification including at least one of the size, tilt, and arrangement interval of a light ray controller, the pitch of sub-pixels of a light-emitting panel, and the arrangement of color filters. In the interpolation process, the color of a phase that is required at the precision of sub-pixel order is calculated. In the sub-pixel rearrangement process, colors are rearranged for each sub-pixel. With these processes, when 2D display is performed on a stereoscopic display which employs a light ray controller typified by a lenticular lens or a parallax barrier, the image quality can be improved while suppressing flicker and color shifts.

### Second Embodiment

The second embodiment will be described next. An image display apparatus according to the second embodiment displays an image when a 2D display region and a 3D display region mix with each other. By performing separate processes for the 2D display region and the 3D display region, the image quality can be improved while suppressing flicker and color shifts, as shown in the first embodiment, for the 2D display region. General stereoscopic vision is performed for the 3D display region.

### <<Entire Configuration>>

FIG. 16 is a block diagram of the image display apparatus according to the second embodiment. In contrast to the image display apparatus shown in the first embodiment, the image display apparatus according to the second embodiment includes a region dividing unit 8, 3D image processing unit 9, and image compositing unit 10. The region dividing unit 8 divides image 1 into a 2D display region and a 3D display region to generate image 5 in the 2D display region and image 6 in the 3D display region. The 3D image processing unit 9 performs image processing of image 6 for 3D display to generate image 7. The image compositing unit 10 composites images 3 and 7 to generate image 8. Also, an interpolation process unit 2 processes image 5 in place of image 1. Image 8 is illuminated by a light-emitting panel.

Each part in the second embodiment, which is different from that in the first embodiment, will be described in detail below.

### <Region Dividing Unit>

The region dividing unit 8 will be described first. In the second embodiment, the region dividing unit 8 divides image 1 into a 2D display region and a 3D display region to generate image 5 in the 2D display region and image 6 in the 3D display region.

As a method of determining the 2D display region and the 3D display region, a flag or coordinate information which is stored in the apparatus as information within image 1 in advance and defines the 2D/3D display regions may be used, depth information which is stored in the apparatus as information within image 1 in advance may be used, or a method of inputting images (parallax images) at a plurality of viewpoints as image 1, and detecting regions free from parallaxes may be used.

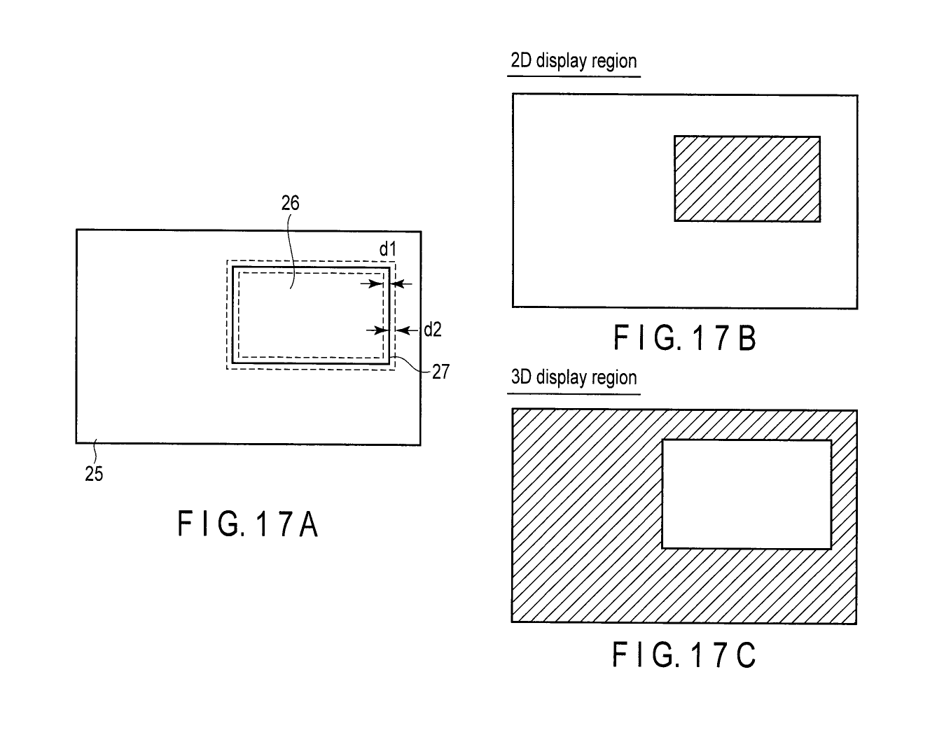

A method of providing an overlap region in region division will be described with reference to FIGS. 17A to 17C. An overlap region is provided to have distances d1 and d2 along vectors perpendicular to a boundary line (a line tangent to the boundary line when the boundary line is a curved line) 27 between a 2D display region 25 and a 3D display region 26 on the display surface, as shown in FIG. 17A. Note that d1 and d2 are rational numbers of 0 or more (unit: pixel, inch, or mm). The display region is divided into the 2D display region 25 and the 3D display region 26, as shown in FIG. 17A, in consideration of this overlap region. For example, the 2D display region 25 displays image 5, and the 3D display region 26 displays image 6. The display region is thus divided, and processes of 2D/3D display are performed for the respective regions.

As another method, a method of not dividing an image itself can also be adopted. This method generates image 1 and a mask image representing the 2D display region as image 5, as shown in FIG. 17B, and generates image 1 and a mask image representing the 3D display region as image 6, as shown in FIG. 17C. In this method, a process for each of the 2D/3D display regions is performed for image 1 (entire region), and composition which uses mask images is performed in a compositing process.

### <3D Image Processing Unit>

The 3D image processing unit 9 will be described next. In this case, the 3D image processing unit 9 performs image processing of image 6 for 3D display to generate image 7. The 3D image processing unit 9 performs a process of assigning an image captured or created at each viewpoint to a corresponding parallax so as to arrange colors for each parallax number, as shown in FIGS. 3A to 3D.

### <Image Compositing Unit>

The image compositing unit 10 will be described. In this case, the image compositing unit 10 composites images 3 and 7 to generate image 8. The image in the 2D display region and that in the 3D display region may be composited using a compositing method of selectively rendering images in the scan line sequence or a method of compositing images using mask images.

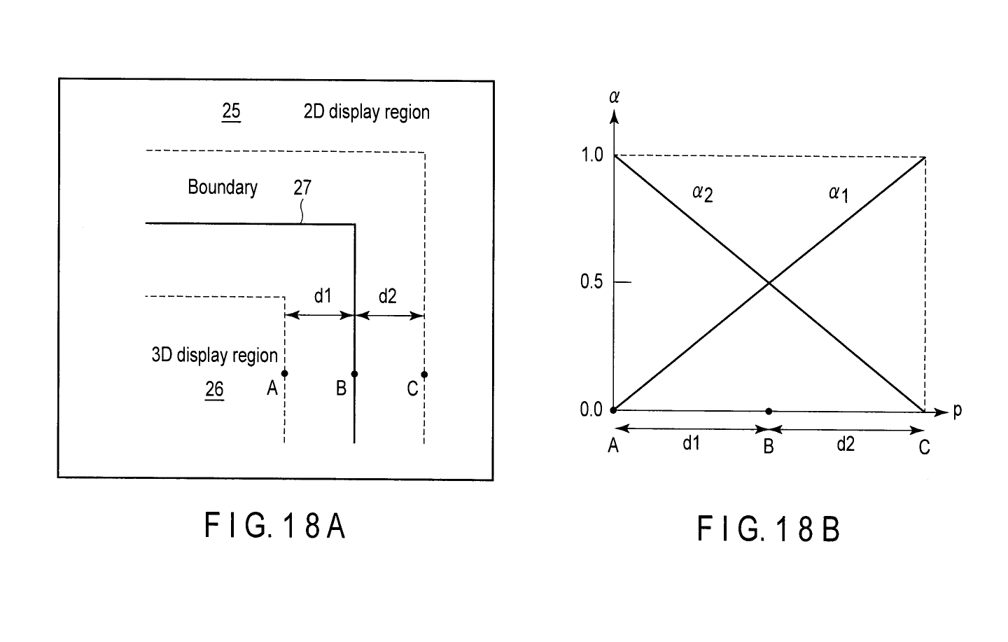

Also, a compositing method which takes the overlap region into consideration in region composition will be described with reference to FIGS. 18A and 18B. In the overlap region, composition based on an alpha blending process which uses predetermined blending ratios (a) in the 2D display region 25 and the 3D display region 26 is performed. For example, as shown in FIG. 18A, letting C1 be the color of the 2D display region 25 in a given overlap region, which has the boundary line 27, and C2 be the color of the 3D display region 26 in the given overlap region, the color C after composition can be calculated by:

C=α1×C1+α2×C2.

where α1 is the blending ratio in the 2D display region, and α2 is the blending ratio in the 3D display region. The blending ratios α1 and α2 can be determined in accordance with the position of the overlap region, as exemplified in a graph of FIG. 18B. Performing such composition makes it possible to improve the image quality of the boundary portion between the 2D/3D display regions.

### <Interpolation Process Unit>

The interpolation process unit 2 will be described. In this case, the interpolation process unit 2 processes image 5 in place of image 1. The interpolation process unit 2 processes image 5 that is part of the 2D display region divided by the region dividing unit 8, instead of processing the whole of image 1 acquired by the image acquisition unit 1. Details of this process are the same as in those described in the first embodiment.

### <<Overall Operation>>

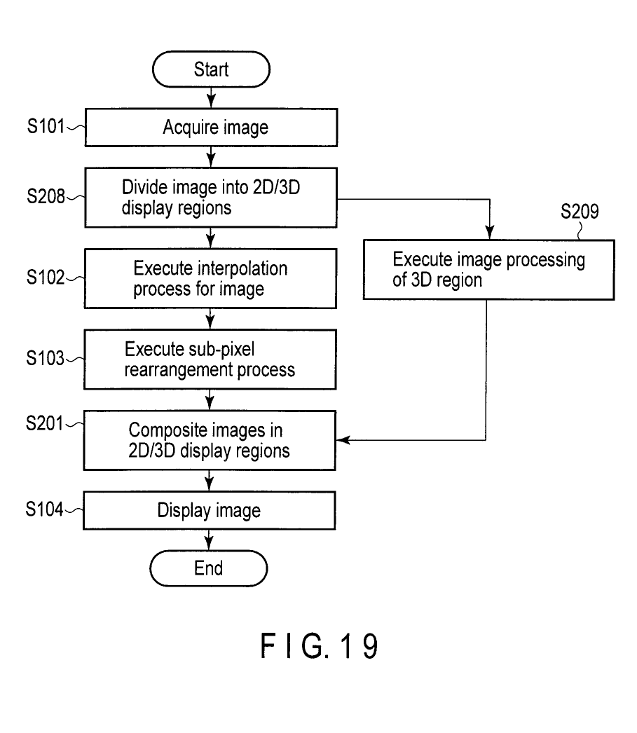

FIG. 19 is a flowchart illustrating an example of the operation of the image display apparatus according to the second embodiment. Differences from the operation of the image display apparatus according to the above-mentioned first embodiment will mainly be described below.

First, in step S101, the same operation as in the image display apparatus according to the first embodiment is executed. Next, in step S208, the image is divided into 2D/3D display regions. The region dividing unit 8 executes this process. In this case, the region dividing unit 8 divides image 1 into a 2D display region and a 3D display region to generate image 5 in the 2D display region and image 6 in the 3D display region. In step S102, an interpolation process is executed for the image. The interpolation process unit 2 executes this process. In this case, the interpolation process unit 2 executes the same process as in the first embodiment for image 5 in place of image 1. In step S103, the same process as in the first embodiment is executed. In parallel with steps S102 and 5103, image processing of the 3D region is executed in step S209. The 3D image processing unit 9 executes this process. In this case, the 3D image processing unit 9 performs image processing of image 6 for 3D display to generate image 7.

In step S210, the images in the 2D/3D display regions are composited. The image compositing unit 10 executes this process. In this case, the image compositing unit 10 composites images 3 and 7 to generate image 8. Lastly, in step S104, the image is displayed. The display unit 4 executes this process. In this case, the display unit 4 uses a display including a light ray controller and light-emitting panel to illuminate image 8 by the light-emitting panel.

With such processes, on a stereoscopic display which employs a light ray controller typified by a lenticular lens or a parallax barrier, separate processes can be performed for the 2D/3D display regions, so the image quality can be improved while suppressing flicker and color shifts for the 2D display region.

According to the above-mentioned embodiment, image display when a 2D display region and a 3D display region mix with each other can be implemented. Hence, by performing separate processes for the 2D display region and the 3D display region, the image quality can be improved while suppressing flicker and color shifts, as shown in the first embodiment, for the 2D display region. General stereoscopic vision can be implemented for the 3D display region.

Note that an image display apparatus including both the sharpening process unit 5 described in the first modification to the first embodiment and the display specification acquisition unit 7 described in the third modification to the first embodiment can also be provided, and a sharpening process may be performed by calculating a second phase from the acquired display specification. Also, a plurality of process units may be integrated and used as a single image filter. Moreover, although the most general arrangement of color filters has been assumed herein, the same processes can also be performed with other arrangements of color filters. A process may be performed for each line or block of an image instead of performing a process for each frame of the image.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image display apparatus comprising:
a display including a light ray controller and a light-emitting panel;
an image acquisition unit configured to acquire a first image;
an interpolation process unit configured to perform an interpolation process for the first image to generate a second image, the interpolation process calculating a color of a first phase which is determined from a display specification including at least one of a size, tilt, and arrangement interval of the light ray controller, a pitch of sub pixels of the light emitting panel, and an arrangement of color filters;
a sub-pixel rearrangement process unit configured to generate a third image by rearranging colors in the second image for each sub-pixel, and
wherein the light-emitting panel illuminates the third image.

2. The apparatus according to claim 1, wherein
the interpolation process unit determines the first phase in accordance with a block in which a plurality of colors of an identical phase are to be rendered in 3D display on the display.

3. The apparatus according to claim 1, wherein
the interpolation process unit determines a plurality of first phases in accordance with a block in which a plurality of colors of an identical phase are to be rendered in 3D display on the display.

4. The apparatus according to claim 1, further comprising:
a sharpening process unit configured to generate a fourth image by performing a sharpening process for the second image based on a second phase which is determined from the display specification,
wherein the sub-pixel rearrangement process unit generates a third image by rearranging colors in the fourth image in place of the second image for each sub-pixel.

5. The apparatus according to claim 1, further comprising:
a viewpoint position acquisition unit configured to acquire a user's viewpoint position,
wherein the interpolation process unit generates a second image by calculating a first phase from the display specification and the user's viewpoint position, and calculating a color of the first phase by an interpolation process for the first image.

6. The apparatus according to claim 1, further comprising:
a display specification acquisition unit configured to acquire information indicating the display specification from outside the apparatus,
wherein the interpolation process unit generates a second image by calculating a first phase from one of the display specification acquired from outside the apparatus and the user's viewpoint position, and calculating a color of the first phase by an interpolation process for the first image.

7. The apparatus according to claim 1, further comprising:
a region dividing unit configured to divide the first image into a 2D display region and a 3D display region to generate a fifth image in the 2D display region and a sixth image in the 3D display region;
a 3D image processing unit configured to perform image processing of the sixth image for 3D display to generate a seventh image; and
an image compositing unit configured to composite the third image and the seventh image to generate an eighth image,
wherein the interpolation process unit generates the third image based on the fifth image, and
the light-emitting panel illuminates the eighth image.

8. The apparatus according to claim 1, wherein
the interpolation process unit performs the interpolation process in accordance with one of linear interpolation, polynomial interpolation, and interpolation which uses a function model, using a color of a known phase of a neighboring pixel.

9. The apparatus according to claim 2, wherein
the interpolation process unit determines the first phase such that the block includes a largest number of samples, or sequentially determines the first phase from a central portion in one of a horizontal direction and a vertical direction within the block.

10. The apparatus according to claim 2, wherein
the first phase is sequentially determined with reference to a phase of a sub-pixel which is observed at a user's postulated viewpoint position.

11. The apparatus according to claim 4, wherein
the sharpening process unit
calculates an average color within a block in which a plurality of colors of an identical phase are to be rendered in 3D display on the display,
calculates a difference between the color of the first phase and the average color within the block to determine the calculated difference as a first color,
performs a sharpening process for the average color within the block using an average color of neighboring blocks, and
determines the color of the first phase by calculating a sum of the sharpened average color within the block and the first color.

12. The apparatus according to claim 5, wherein
the interpolation process unit sequentially determines the first phase upon defining, as a center, a phase of a sub-pixel, which is observed at the acquired user's viewpoint position within a given block.

13. The apparatus according to claim 7, wherein
the region dividing unit forms an overlap region in which the 2D display region and the 3D display region overlap each other, and
the image compositing unit composites, by an alpha blending process, the 2D display region and the 3D display region which define the overlap region.

14. An image display method comprising:
acquiring a first image;
generating a second image by calculating, by an interpolation process for the first image, a color of a first phase which is determined from a display specification including at least one of a size, tilt, and arrangement interval of a light ray controller, a pitch of sub-pixels of a light-emitting panel, and an arrangement of color filters; and
generating a third image by rearranging colors in the second image for each sub-pixel,
wherein the third image is illuminated.

15. A recording medium recording a program for:
acquiring a first image;
generating a second image by calculating, by an interpolation process for the first image, a color of a first phase which is determined from a display specification including at least one of a size, tilt, and arrangement interval of a light ray controller, a pitch of sub-pixels of a light-emitting panel, and an arrangement of color filters; and
generating a third image, to be illuminated, by rearranging colors in the second image for each sub-pixel.
